(19) United States
(12) Patent Application Publication
(10) Pub. No.: US 2016/0203199 A1
(43) Pub. Date: Jul. 14, 2016

(54) LOCATION COORDINATE CONVERSION SERVICE, METHOD AND SYSTEM

(71) Applicant: Point Inside, Inc., Bellevue, WA (US)

(72) Inventors: Geary Eppley, Carnation, WA (US); Howard Fain, Auburn, WA (US)

(21) Appl. No.: 14/994,085

(22) Filed: Jan. 12, 2016

Related U.S. Application Data
(60) Provisional application No. 62/102,519, filed on Jan. 12, 2015.

(51) Int. Cl. G06F 17/30

(52) U.S. Cl. CPC G06F 17/30569; G06F 17/30241

(57) ABSTRACT

One or more transformations are determined between a first, a second, and nth coordinate systems; the transformations are used to transform coordinates between the coordinate systems. The transformed coordinates may be used to provide maps and location services to end users, without inaccuracies which can occur when a user's location is provided in the first coordinate system but the user's location needs to be output to a map which uses the second or nth coordinate system.

### CROSS-REFERENCE TO RELATED APPLICATION

This application claims the benefit of U.S. Provisional Application No. 62/102,519, filed Jan. 12, 2015, the entire disclosure of which is incorporated by this reference for all purposes.

### FIELD

This disclosure relates to a method and system for converting location coordinates in one coordinate system into coordinates in a second or nth coordinate system.

### BACKGROUND

The following description includes information that may be useful in understanding the present invention. It is not an admission that any of the information provided herein is prior art or relevant to the presently claimed invention, or that any publication specifically or implicitly referenced is prior art.

Location services as discussed herein refers to any service which determines the location of a computer, referred to herein as a “Target”, utilizing a set of “Location Beacons”. Location Beacons have a known location in the location service. Location Beacons wirelessly transmit information, such as an identifier of each Location Beacon, coordinates of the Location Beacon, or the like, which wireless signal is received at the Target. The Target may be a mobile computing device coupled with a wireless transceiver, such as a (smart) cell phone, a GPS device, or the like. The Target decodes the wireless signal from the Location Beacon, the information, and the wireless signal strength. The Target may also detect the (probable) direction along which the wireless signal was transmitted. A Location Beacon can be a satellite, as in the Global Position System (“GPS”), a Wi-Fi transceiver (usually in a Wi-Fi base station), a cell-phone base station, a blue-tooth transmitter, a RFID/Near Field Communication transmitter, or the like. The Target obtains the location of the Location Beacon, either directly or via a server, via the information transmitted by the Location Beacon. This information can be used, in conjunction with the wireless signal strength, to estimate the location of the Target. If a signal from more than one Location Beacon is available and/or if the Target has more than one receiving antenna in a known spatial relationship, multilateration can be used to refine the location of the Target. Location services can be provided “in reverse”, wherein the Target wirelessly transmits identifying information which is received at one or more receivers (such as in certain of the devices listed above as “Location Beacons”), and wherein the location of the Target is estimated (including via multilateration) as described above.

The coordinates returned by location services are often treated as immutable facts. However, different location services may return different locations for the same Target. In many contexts, it is acceptable for the information from the location service to be approximate. However, if a Target is a mobile device possessed by an end user in a retail store, and if the location is used to determine a path for or of the Target, the approximate location may result in a physically impossible path, such as one which goes through shelves. Or, if a path is provided to the Target, the starting point may be in an incorrect aisle which may result in an incorrect or undesirable path.

Correction of coordinates returned by a location service may be possible through application of linear functions. See, for example, FIG. 4, which shows a Reference Map 400 of a retail location and FIG. 5, which shows the Reference Map 400 and the walking path 505 of a mobile device. The walking path 505 is inaccurate relative to the Reference Map 400, showing that the end user walked through aisles. The walking path 505 also shows endemic inaccuracies, such as that the path, particularly along the right side, is not continuous (as the walking path of a person would be) but shows “breaks”, as though the end user jumped. FIG. 6 shows Reference Map 400 and the walking path, though now the walking path has been corrected to walking path 605 by shifting walking path 505 up and to the left, which are linear functions.

However, in certain cases, it is not possible to correct the coordinates from one system to another simply by shifting the coordinates of one or the other of the systems. For example, FIG. 7 shows a map 700 of the retail location illustrated in FIG. 5, but the scale in map 700 is compressed relative to map 400, map 700 is slightly rotated relative to map 500, and the top of map 700 is slightly compressed relative to the bottom of map 700 due to a slight perspective “view” of the map or due to non-linear distortions (which may be an artifact of perspective in a photograph, the “knitting” of disparate source material or the like which was used to generate map 700—this final factor is subtle and may not be visible in map 700). FIG. 8 illustrates these problems by overlaying map 700 on map 400. Simply shifting coordinates will not correct the discrepancies which occur between these two maps. Correction of the discrepancies between maps 500 and 700 is not uniform or linear, even between just these two maps.

### BRIEF DESCRIPTION OF THE DRAWINGS

FIG. 1 is a network and device diagram illustrating exemplary computing devices configured according to embodiments disclosed in this paper.

FIG. 2 is a functional block diagram of an exemplary PI Server computing device and some data structures and/or components thereof.

FIG. 3 is a functional block diagram of PI Server Datastore.

FIG. 4 is a reference map of a location, as discussed herein.

FIG. 5 is the reference map of FIG. 4 and a walking path with coordinates provided by a location service.

FIG. 6 illustrates a linear correction of the walking path of FIG. 5.

FIG. 7 illustrates a map of the location of FIG. 4, but with a coordinate system which differs in a non-linear way from the coordinate system in the reference map of FIG. 4.

FIG. 8 illustrates the maps of FIGS. 4 and 7, overlaid.

FIG. 9 illustrates selection of Anchor Points in the maps of FIGS. 4 and 7 and the drawing of transects between the Anchor Points.

FIG. 10 is a flowchart illustrating Off-Set Determiner module.

FIG. 11 is a flowchart illustrating Off-Set Applier module.

### DETAILED DESCRIPTION

The following Detailed Description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list.

Multiple instances of certain components may be labeled with the same element number and a different letter; all such component instances are equivalent within normal ranges. Multiple instances of otherwise identical components can control, be controlled, or communicate separately through assignment of unique or distinguishing identifiers. Such components may be referred to herein only by element number, without a letter in conjunction therewith, in which case the reference is to any of such components.

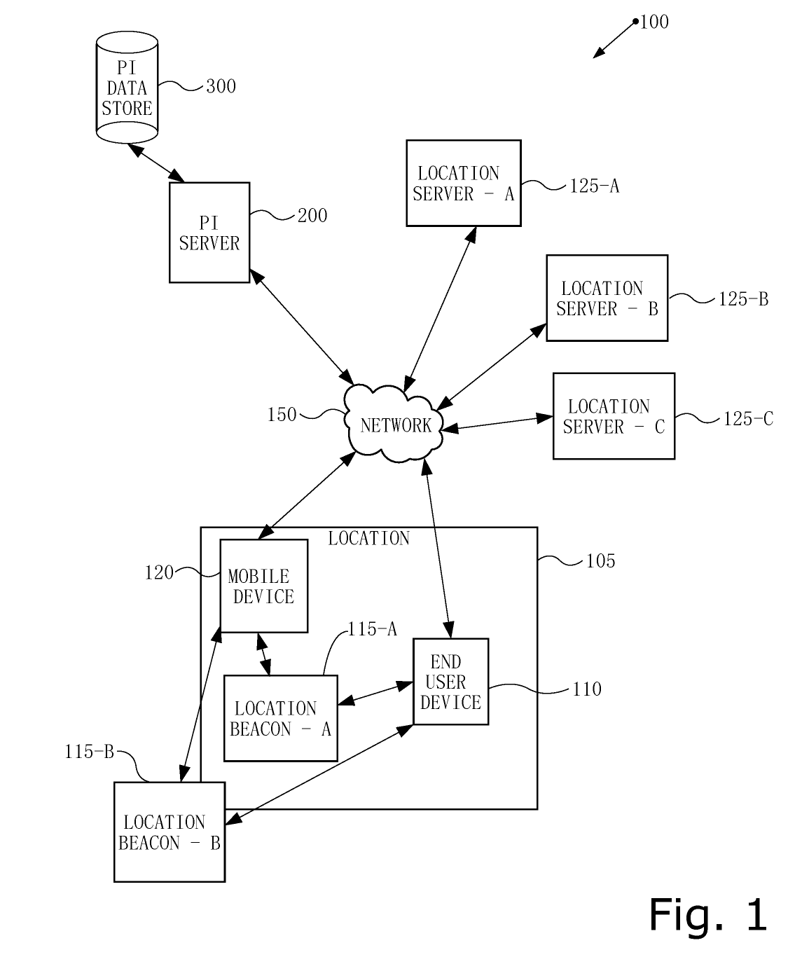

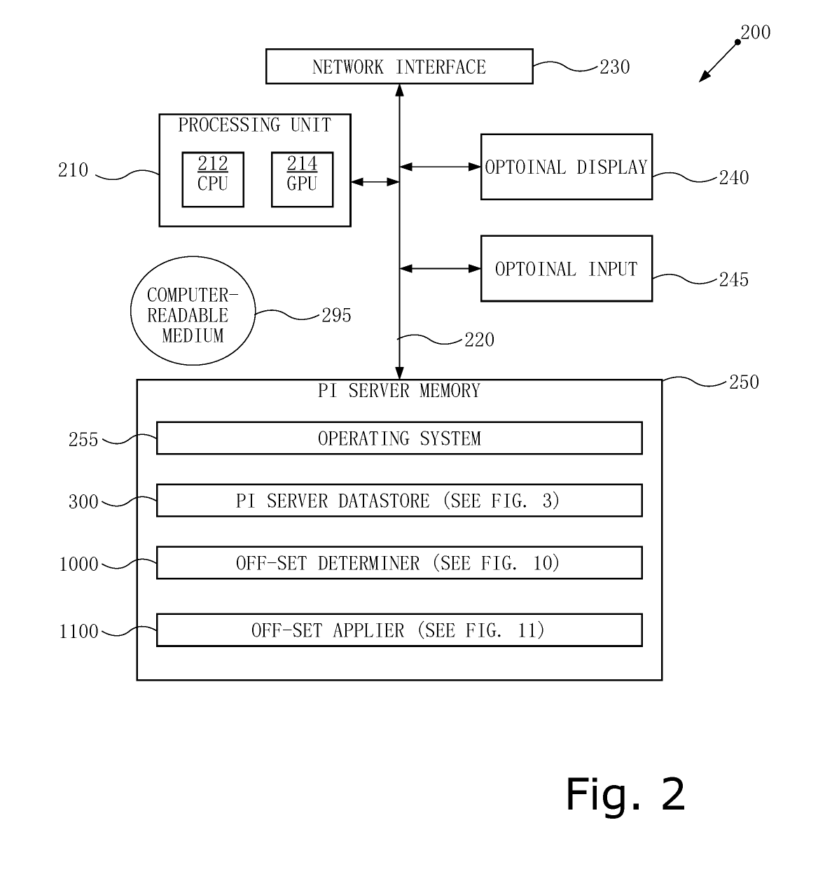

FIG. 1 is a network and device diagram illustrating exemplary computing devices configured according to embodiments disclosed in this paper. In general terms, PI Server 200 is a computer (PI Server 200 is further described in relation to FIG. 2). PI Server 200 receives a coordinate for a first location, such as Location 105, from a first source, such as Location Server-A 125-A. Location Server-N 125N is a computer. The PI Server 200 also receives a coordinate for Location 105 from a second source, such as Location Server-B 125-B. To determine the discrepancy (if any) between the two coordinate systems, the PI Server 200 executes Off-Set Determiner 1000 and determines a transformation between the two coordinates, which may be saved as Non-Linear Transform 320 or Linear Transform 315.

To acquire data which may be used by Off-Set Determiner 1000, a mobile computing device such as Mobile Device 120 may be deployed to Location 105, which Mobile Device 120 may communicate location information, generally obtained from one of the Location Servers 125 (-A, -B, or -C), to PI Server 200. The location information of Mobile Device 120 may be communicated directly by Mobile Device 120 to PI Server 200 or via one of the Location Servers 125. The location information of Mobile Device 120 may be obtained through use of a Location Beacon 115, as discussed above. Mobile Device 120 may be a cell phone, a laptop, or the like. A third or additional coordinate for Location 105 may also be received, such as from Location Server-C 125-C, and Non-Linear Transform 320 or Linear Transform 315 may be determined relative to one of the first two coordinates. One of the coordinate systems of one of the Location Servers 125 may be selected as a reference for determining Non-Linear Transform 320 or Linear Transform 315.

Discussion herein of a “Reference Map”, “Reference Coordinate System”, “Reference Coordinate” or of a “Source Map”, “Source Coordinate System”, or “Source Coordinate” should both be understood to refer to a map, coordinate system or coordinate from a Location Server 125; one may be selected as a reference into which other coordinates are to be transformed and may therefore be referred to as a “reference” while the coordinates which are being transformed are referred to as the “source”. Reference Coordinates 305, Source Coordinates 310 and Anchor Point 330 records may all be understood as Coordinates, which Coordinates may be distinguished according to association with a Location Server 125 or Location Server 325 record.

By way of example, PI Server 200 may receive a request to locate a mobile computing device, such as End User Device 110, in a map, which map utilizes a coordinate system from Location Server-A 125-A, though the location of End User Device 110 is provided to PI Server 200 by Location Server-B 125-B. As discussed above, the coordinate systems utilized by the different Location Servers 125 may be slightly different, whether or not the Location Servers 125 are utilizing the same Location Beacons 115 or different Location Beacons 115.

PI Server 200 would like to provide a map with is as accurate as possible, or which is at least consistent, notwithstanding the differences between the coordinate systems utilized by the different Location Servers 125. PI Server 200 executes Off-Set Applier 1100 to assemble and apply the appropriate Non-Linear Transform 320 or Linear Transform 315 to convert the coordinates from Location Server-B 125-B to coordinates appropriate to Location Server-A 125-A, for output in the map which is to be rendered on End User Device 110. To determine Non-Linear Transform 320 or Linear Transform 315, PI Server 200 executes Off-Set Determiner 1000.

Network 150 illustrated in FIG. 1 comprises computers, network connections among the computers, and software routines or modules to enable communication between the computers over the network connections. Examples of the Network 150 comprise an Ethernet network, the Internet, and/or a wireless network, such as a GSM, TDMA, CDMA, EDGE, HSPA, LTE, LTE Advanced or other network provided by a wireless service provider. Connection to the Network 150 may be via a wireless or wireline connection. More than one network may be involved in a communication session between the illustrated devices. Connection to the Network 150 may require that the computers execute software routines or modules which enable, for example, the seven layers of the OSI model of computer networking or equivalent in a wireless phone network.

PI Server 200 may comprise or be connected to PI Datastore 300 (discussed further below). This paper may discuss a first computer or computer process as connecting to a second computer or computer process (such as Mobile Device 120 connecting to PI Server 200) or to a corresponding datastore (such as to PI Datastore 300); it should be understood that such connections may be to, through, or via the other of the two components (for example, a statement that Mobile Device 120 connects with or sends data to PI Server 200 should be understood as saying that the computing device may connect with or send data to PI Datastore 300). References herein to “database” should be understood as equivalent to “Datastore.” Although illustrated as components integrated in one physical unit, the computers and databases may be provided by common (or separate) physical hardware and common (or separate) logic processors and memory components. Though discussed as occurring within one computing device, the software routines or modules and data groups used by the software routines or modules may be stored and/or executed remotely relative to any of the computers through, for example, application virtualization.

FIG. 2 is a functional block diagram of an exemplary PI Server 200 computing device and some data structures and/or components thereof. PI Server 200 comprises at least one Processing Unit 210, PI Server Memory 250, Display 240 and Input 245, all interconnected along with Network Interface 230 via Bus 220. Processing Unit 210 may comprise one or more general-purpose Central Processing Units (“CPU”) 212 as well as one or more special-purpose Graphics Processing Units (“GPU”) 214.

The components of Processing Unit 210 may be utilized by Operating System 255 for different functions required by modules executed by PI Server 200. Network Interface 230 maybe utilized to form connections with Network 150 or to form device-to-device connections with other computers. PI Server Memory 250 generally comprises a random access memory (“RAM”), a read only memory (“ROM”), and a permanent mass storage device, such as a disk drive or SDRAM (synchronous dynamic random-access memory). PI Server Memory 250 stores program code for software modules, such as, for example, Off-Set Determine 1000 and Off-Set Applier 1100 module, as well as, for example, browser, email client and server modules, client applications, and database applications (discussed further below). Additional data groups for modules, such as for a webserver and web browser, may also be present on and executed by PI Server 200. Webserver and browser modules may provide an interface for interacting with the other computing devices illustrated in FIG. 1 or with other computing devices not illustrated in FIG. 1, for example, through webserver and web browser modules (which may serve and respond to data and information in the form of webpages and html documents or files). The browsers and webservers are meant to illustrate user- and machine-interface modules generally, and may be replaced by equivalent modules for serving and rendering information to and in an interface in a computing device (whether in a web browser or in, for example, a mobile device application, or an API call to a server, a library, or the like).

In addition, PI Server Memory 250 also stores Operating System 255. These software components may be loaded from a non-transient Computer Readable Storage Medium 295 into PI Server Memory 250 of the computing device using a drive mechanism (not shown) associated with a non-transient Computer Readable Storage Medium 295, such as a floppy disc, tape, DVD/CD-ROM drive, memory card, or other like storage medium. In some embodiments, software components may also or instead be loaded via a mechanism other than a drive mechanism and Computer Readable Storage Medium 295 (e.g., via Network Interface 230).

PI Server 200 may also comprise hardware supporting input modalities, Input 245, such as, for example, a touchscreen, a camera, a keyboard, a mouse, a trackball, a stylus, motion detectors, and a microphone. Input 245 may also serve as Display 240, as in the case of a touchscreen display which also serves as Input 245, and which may respond to input in the form of contact by a finger or stylus with the surface of Input 245. Input 245 and Display 240 may physically be part of PI Server 200 and/or may be a component(s) of another device.

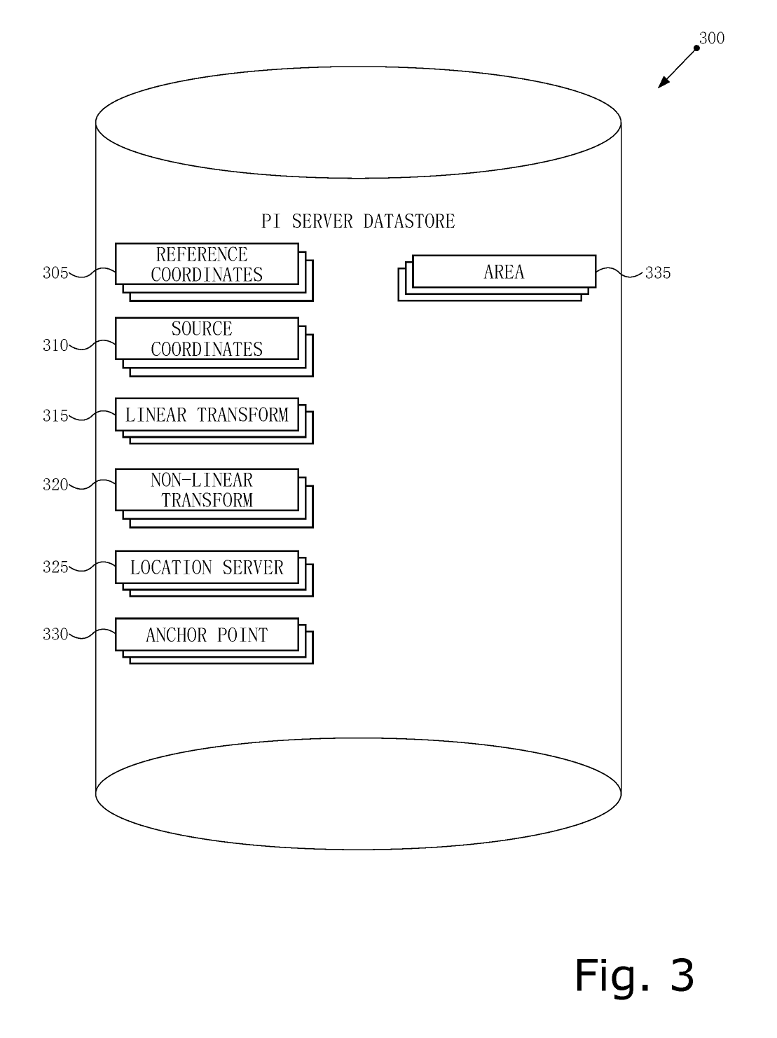

PI Server 200 may also comprise or communicate via Bus 220 with PI Datastore 300, illustrated further in FIG. 3. In various embodiments, Bus 220 may comprise a storage area network (“SAN”), a high speed serial bus, and/or via other suitable communication technology. In some embodiments, PI Server 200 may communicate with PI Datastore 300 via Network Interface 230. PI Server 200 may, in some embodiments, include many more components than those shown in FIGS. 2 and 3. However, it is not necessary that all of these generally conventional components be shown in order to disclose an illustrative embodiment.

FIG. 3 is a functional block diagram of PI Server Datastore 300. The illustrated components of the PI Datastore 300 are data groups used by modules and are discussed further herein in the discussion of other of the Figures.

The data groups used by modules illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and the like.

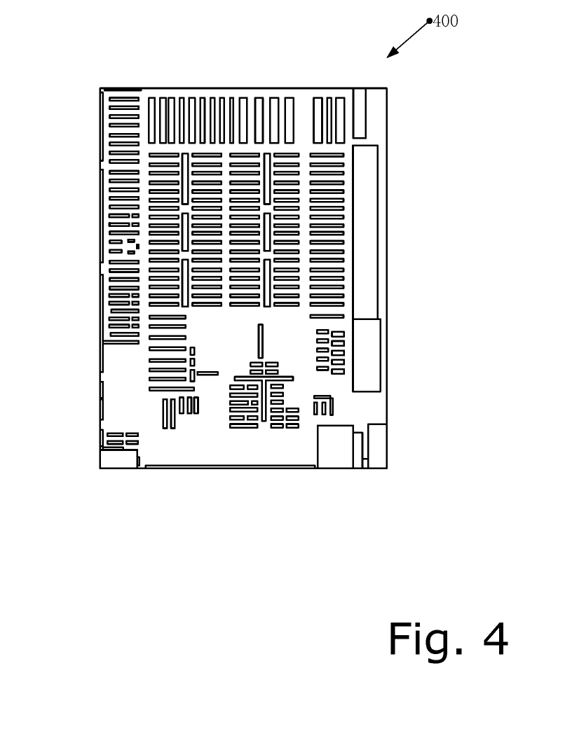

FIG. 4, discussed above, illustrates Reference Map 400. Reference Map 400 may have a coordinate system, coordinates of which may be stored as or in Reference Coordinate 305 records. Reference Map 400 may be provided by, for example, Location Server-A 125-A. Location Server-A 125-A may be operated by the party operating PI Server 200 or by any other party. Reference Map 400 may not be provided in a graphical map form, but may be provided as a set of coordinates.

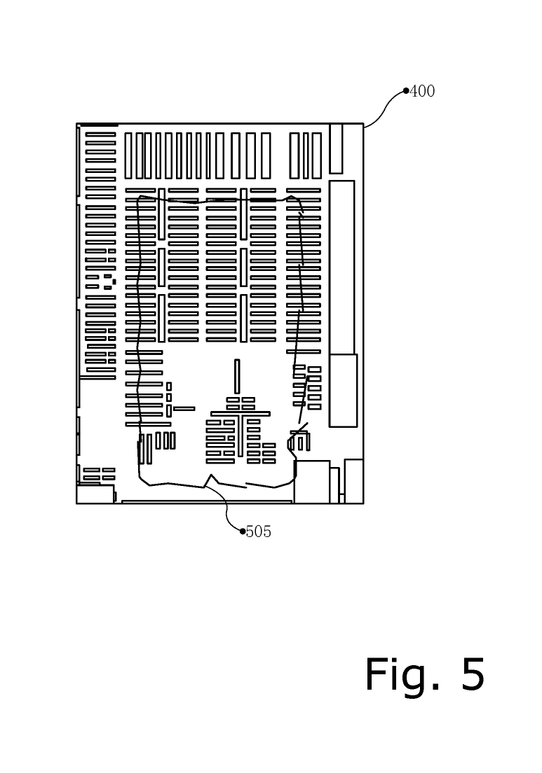

FIG. 5, discussed above, illustrates Reference Map 400 with Walking Path 505. Walking Path 505 may be provided by, for example Location Server-B 125-B. Location Server-B 125-B may be operated by the party operating PI Server 200 or by any other party. Walking Path 505 may be provided as a set of Source Coordinates 310. Walking Path 505 may not be provided in map form, but may be provided as a set of coordinates. Certain of the Source Coordinates 310 and Reference Coordinates 305 may be “Anchor Points 330”, discussed further herein. Anchor Points 330 may be discrete locations at, for example, geographically or topologically identifiable features.

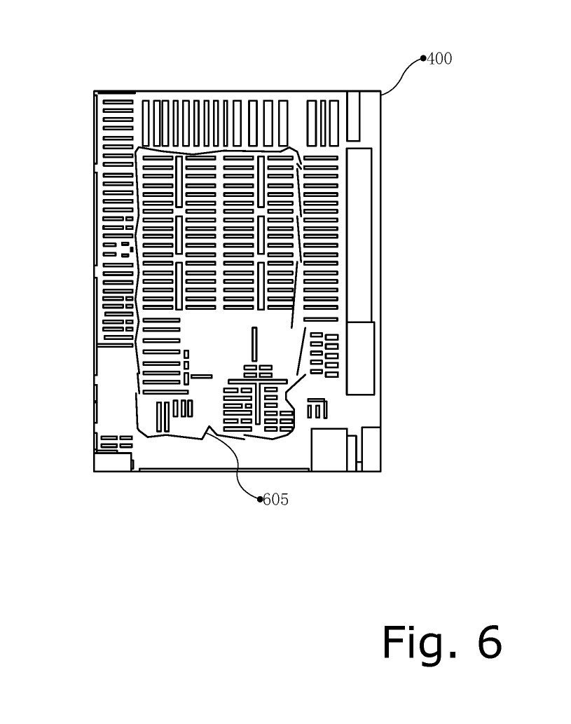

FIG. 6, discussed above, illustrates Reference Map 400 with Walking Path 605. Walking Path 605 is generally the same as Walking Path 505, though Walking path 605 has been shifted to fit within Reference Map 400 by application of linear transformations which may be summarized as “up X units and left Y units.”

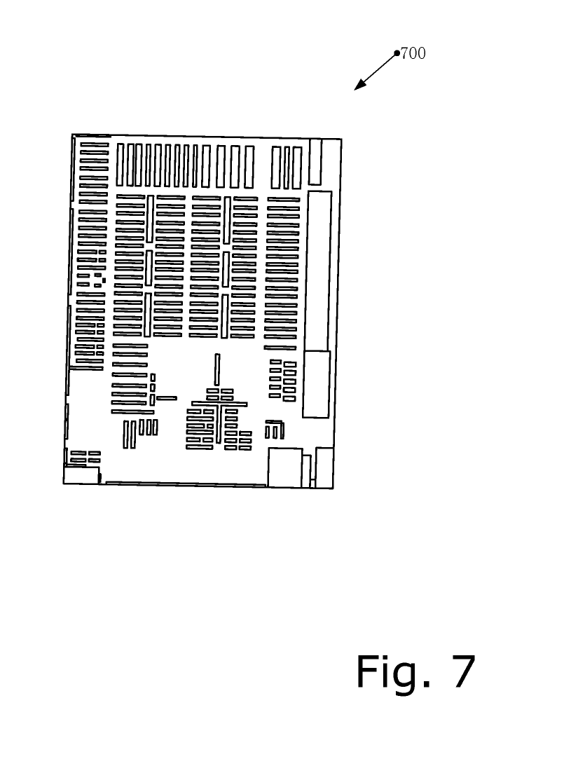

FIG. 7, discussed above, illustrates Source Map 700. Source Map 700 may be provided by Location Server-C 125-C. Source Map 700 may not be provided in map form. Source Map 700 may be provided and/or saved as a set of Source Coordinates 310. As discuss above, Source Map 700 is generally of or derived from Location 105. Compared to Reference Map 400, Source Map 700 is rotated, has a compressed scale, and the top of Source Map 700 is compressed in scale, relative to the bottom of Source Map 700. The coordinate system of Source Map 700 may not be reconciled with Reference Map 400 through application of a linear function.

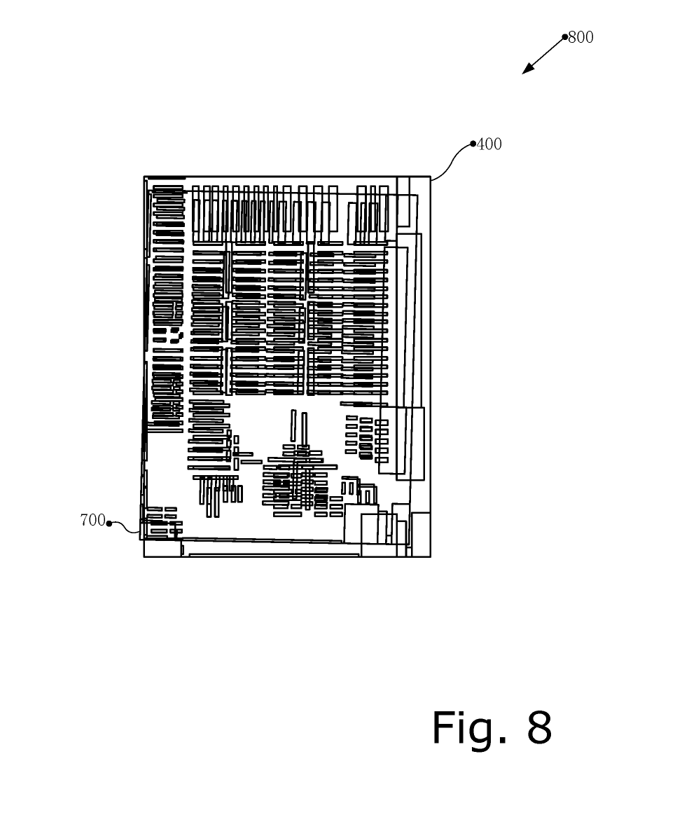

FIG. 8 overlays Reference Map 400 and Source Map 700 for the purpose of illustrating that the coordinate systems of the two maps cannot be reconciled through application of a linear function.

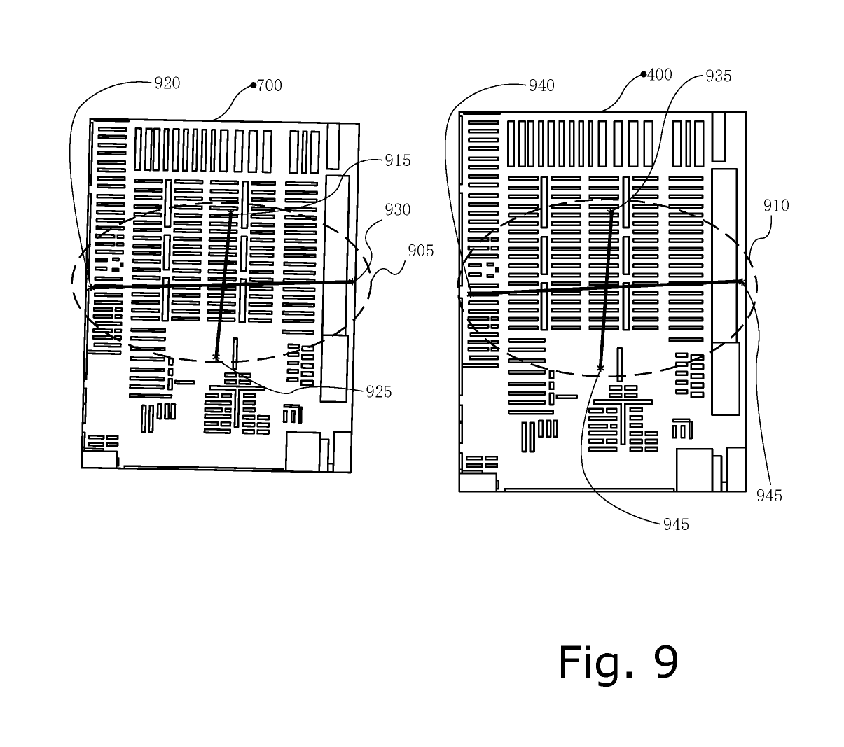

FIG. 9 graphically illustrates identification of common Anchor Points 915, 920, 925, 930 in Source Map 700 and in Reference Map 400 at Anchor Points 935, 940, 945, and 950. The common Anchor Points are illustrated within ovals 905 and 910, at the end of heavy-weight lines which transect between the Anchor Points. The Anchor Points may geographic, topologic, or other features in Location 105 which are unambiguously identifiable. A corner of a building or the like may be selected as an Anchor Point. As discussed above, data regarding the Anchor Points may be obtained by travelling to the location and collecting data from Location Servers 125. Data regarding the Anchor Points may also be obtained by obtaining maps or coordinate systems from or used by Location Servers 125, which maps may include unambiguous physical landmarks, such as the corners of buildings and the like. Coordinates of Anchor Points 915-950 may be stored in PI Datastore 300 as Anchor Point 330 records, which Anchor Point records may also be understood as a subset of Coordinate records generally. Anchor Points 330 may be used in Off-Set Determiner 1000.

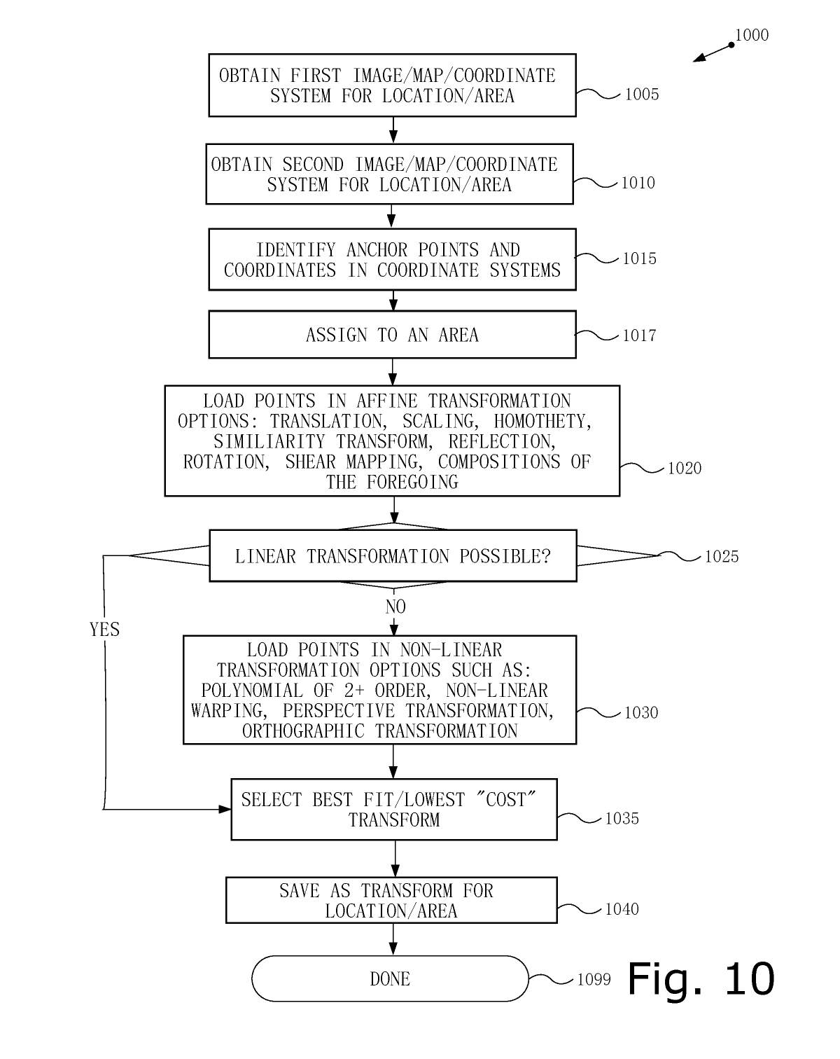

FIG. 10 is a flowchart illustrating Off-Set Determiner 1000 module. Off-Set Determiner 1000 may be executed by, for example, PI Server 200.

At block 1005, Off-Set Determiner 1000 obtains a first reference image, map, coordinate, or set of coordinates (referred to as a “reference map”, such as Reference Map 400) from a first source, such as Location Server-A 125-A.

At block 1010, Off-Set Determiner 1000 obtains a source Image, map, coordinate, or set of coordinates (referred to as a “source map”, such as Source Map 700) from a second source, such as Location Server-B 125-B.

At block 1015, a set of Anchor Points 330 in each of the reference map and the source map are identified; the set may comprise four points in each, a total of eight Anchor Points 330 total, four in each of the reference map and the source map. Off-Set Determiner 1000 may obtain the Anchor Points 330 by deploying Mobile Device 120 to Location 105, positioning Mobile Device 120 to each of the Anchor Points 330, and obtaining the coordinates for the Anchor Points 330 from each of Location Server-A and Location Server-B. Alternatively, if one (or both) of the Location Servers provides a map of the first location with latitude and longitude associated with pixels in the graphical output of the map, the Anchor Points 330 may be located in the pixels and the corresponding latitude and longitude of the pixels may be obtained from each of Location Server-A and Location Server-B. Generally, the latitude and longitudes for the Anchor Points 330 will not be the same between Location Server-A and Location Server-B.

At block 1017, Off-Set Determiner 1000 may assign Anchor Points 330 to an area, such as an area in or corresponding to the source or reference map. The assigned area may be stored as, for example, an Area 335 record.

At block 1020, Off-Set Determiner 1000 may load the Anchor Points 330 into a range of functions for performing affine transformations, such as, for example, a translation function, a scaling function, a homothety function, a similarity transform function, a reflection function, a rotation function, a shear mapping function, or a composition of the foregoing functions.

At block 1025 Off-Set Determiner 1000 may determine, based on the output of bock 1020, whether a consistent, linear correction or affine transformation may be applied to reconcile the Anchor Points 330 between the Location Servers. A consistent linear or affine correction is equivalent to the correction illustrated in relation to FIG. 6 (between Walking Path 505 and Walking Path 605).

If negative at block 1025, then at block 1030, Off-Set Determiner 1000 may load the Anchor Points 330 into non-linear transformation function options, such as, for example, a polynomial of 2+ order (or an integration function for determining such a polynomial), a non-linear warping function, a non-linear perspective transformation function, a non-linear orthographic transformation function or the like.

Following block 1030 or if affirmative at block 1025, at block 1035 Off-Set Determiner 1000 may select which of the affine or non-linear functions produced a best fit and/or which produced an acceptable fit with a lowest computational cost.

At block 1040, the output of block 1035 may be saved as Linear Transform 315 or Non-Linear Transform 320 for the Area 335.

The steps of Off-Set Determiner 1000 may be performed for multiple coordinate systems from multiple Location Servers, such as Location Server-A through Location Server-N. One of the coordinate systems from one of the Location Servers may be used as a reference, against which Non-Linear Transform 320 for each of the other coordinate systems may be determined. Conversion between coordinate systems may then involve a first conversion, relative to the reference, and then another conversion, back out to the desired output coordinate system.

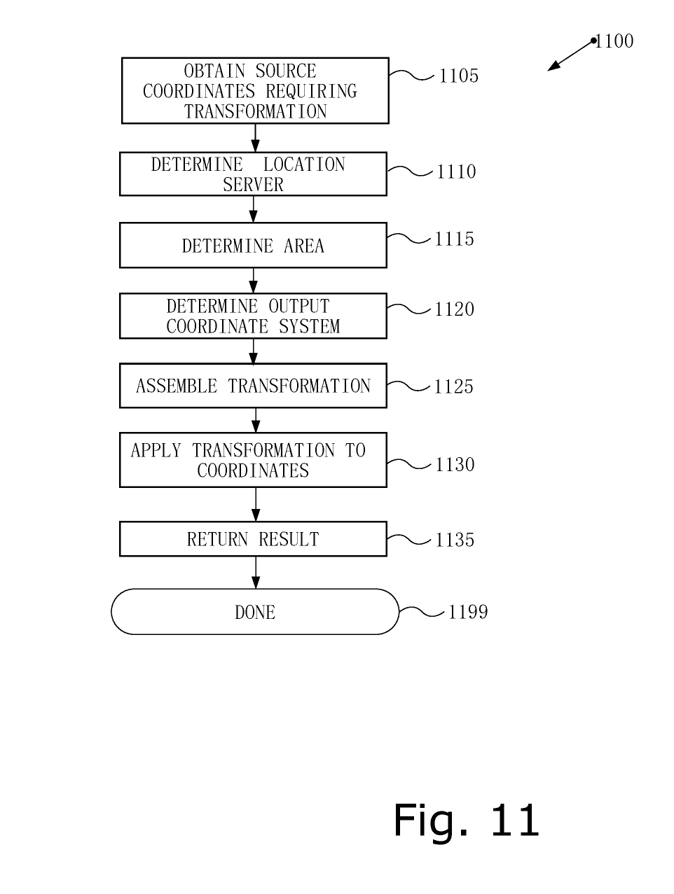

FIG. 11 is a flowchart illustrating Off-Set Applier 1100 module, as may be executed by, for example, PI Server 200.

At block 1105, Off-Set Applier 1100 obtains a set of source coordinates from or associated with an end user, such as End User Device 110, or from another party or device, which source coordinates are to be converted into an output coordinate system.

At block 1110, Off-Set Applier 1100 may obtain or determine the Location Server which provided the source coordinates of the end user.

At block 1115, an area in which the source coordinates occurs may be obtained, such as Area 335.

At block 1120, an output coordinate system, such as that of another Location Server, may be determined or obtained, such as according to a map or coordinate system into which the output of Off-Set Applier 1100 is to be applied.

At block 1125, a Transform for transforming the source coordinates into the output coordinate system may be assembled.

At block 1120, the correction factor for the source coordinates of the end user relative to the reference coordinate system may be obtained or determined, according to the Linear Transform 315 or Non-Linear Transform 320 between the source coordinate system and the reference coordinate system.

At block 1130, the result of block 1125 may be returned. The result may returned as, for example, a map drawn according to the reference coordinate system, showing the path of the end user according to location data provided according to the source coordinate system.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform modules having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of coordinate transformation, comprising:
in a computing device comprising a processor and a memory, which memory comprises instructions for an off-set determiner module and an off-set applier module;
with the off-set determiner module,
obtaining a first and a second anchor point in a first coordinate system and a first and a second anchor point in a second coordinate system, which first anchor points in the coordinate systems are corresponding anchor points because they were obtained at a first same location in the real world and which second anchor points in the coordinate systems are corresponding anchor points because they were obtained at a second same location in the real world,
determining that at least one set of the corresponding anchor points in the coordinate systems do not have the same values
determining a transformation to make the corresponding anchor points in the coordinate systems have similar values and saving the transformation;
with the off-set applier module,
receiving a coordinate in the first coordinate system,
identifying an output coordinate system,
assembling an output transformation to transform the first coordinate into an output coordinate in the output coordinate system, which output transformation comprises the transformation,
transforming the coordinate in the first coordinate system into the output coordinate according to the assembled output transformation, and
outputting the output coordinate to a map system which utilizes the output coordinate system.

2. The method according to claim 1, wherein the transformation is a first transformation, wherein the output coordinate system is a third coordinate system, and wherein assembling the output transformation comprises combining the first transformation with a second transformation, which second transformation transforms coordinates in the second coordinate system into coordinates in the third coordinate system.

3. The method according to claim 1, further comprising associating the first and second anchor points in the coordinate systems with an area, associating the transformation with the area, determining that the coordinate in the first coordinate system is within the area, and selecting the transformation at least in part because it is associated with the area.

4. The method according to claim 1, wherein determining the transformation comprises identifying a linear or a non-linear transformation to make the corresponding anchor points in the coordinate systems have similar values.

5. The method according to claim 4, wherein the linear transformation comprises an affine transformation.

6. The method according to claim 5, wherein the affine transformation comprises at least one of a translation, a scaling, a homothety, a similarity transformation, a reflection, a rotation, a shear mapping, and a composition of the foregoing.

7. The method according to claim 4, wherein the non-linear transformation comprises at least one of a polynomial of 2+ order, a non-linear warping, a perspective transformation, and an orthographic transformation.

8. The method according to claim 1, wherein determining the transformation comprises identifying a transformation which produces a minimum error.

9. An apparatus for performing coordinate transformation, which apparatus comprises:
a computing device comprising a processor and a memory, which memory comprises instructions for an off-set determiner module and an off-set applier module;
wherein the off-set determiner module is to:
obtain a first and a second anchor point in a first coordinate system and a first and a second anchor point in a second coordinate system, which first anchor points in the coordinate systems are corresponding anchor points because they were obtained at a first same location in the real world and which second anchor points in the coordinate systems are corresponding anchor points because they were obtained at a second same location in the real world,
determine that at least one set of the corresponding anchor points in the coordinate systems do not have the same values,
determine a transformation to make the corresponding anchor points in the coordinate systems have similar values and saving the transformation;
wherein the off-set applier module is to:
receive a coordinate in the first coordinate system,
identify an output coordinate system,
assemble an output transformation to transform the first coordinate into an output coordinate in the output coordinate system, which output transformation comprises the transformation,
transform the coordinate in the first coordinate system into the output coordinate according to the assembled output transformation, and
output the output coordinate to a map system which utilizes the output coordinate system.

10. The apparatus according to claim 9, wherein the transformation is a first transformation, wherein the output coordinate system is a third coordinate system, and wherein assemble the output transformation comprises combine the first transformation with a second transformation, which second transformation transforms coordinates in the second coordinate system into coordinates in the third coordinate system.

11. The apparatus according to claim 9, further wherein the off-set determiner module is further to associate the first and second anchor points in the coordinate systems with an area; wherein the off-set applier module is further to associate the transformation with the area, determine that the coordinate in the first coordinate system is within the area, and select the transformation at least in part because it is associated with the area.

12. The apparatus according to claim 9, wherein determine the transformation comprises identify a linear or a non-linear transformation to make the corresponding anchor points in the coordinate systems have similar values.

13. The method according to claim 12, wherein the linear transformation comprises an affine transformation.

14. The method according to claim 13, wherein the affine transformation comprises at least one of a translation, a scaling, a homothety, a similarity transformation, a reflection, a rotation, a shear mapping, and a composition of the foregoing.

15. The method according to claim 12, wherein the non-linear transformation comprises at least one of a polynomial of 2+ order, a non-linear warping, a perspective transformation, and an orthographic transformation.

16. The apparatus according to claim 9, wherein determine the transformation comprises identify a transformation which produces a minimum error.

17. One or more computer-readable media comprising instructions that cause a computing device, in response to execution of the instructions by one or more processors of the computing device, to:
obtain a first and a second anchor point in a first coordinate system and a first and a second anchor point in a second coordinate system, which first anchor points in the coordinate systems are corresponding anchor points because they were obtained at a first same location in the real world and which second anchor points in the coordinate systems are corresponding anchor points because they were obtained at a second same location in the real world;
determine that at least one set of the corresponding anchor points in the coordinate systems do not have the same values;
determine a transformation to make the corresponding anchor points in the coordinate systems have similar values and saving the transformation;
receive a coordinate in the first coordinate system;
identify an output coordinate system;
assemble an output transformation to transform the first coordinate into an output coordinate in the output coordinate system, which output transformation comprises the transformation,
transform the coordinate in the first coordinate system into the output coordinate according to the assembled output transformation; and
output the output coordinate to a map system which utilizes the output coordinate system.

18. The computer readable-media according to claim 17, wherein the transformation is a first transformation, wherein the output coordinate system is a third coordinate system, and wherein assemble the output transformation comprises combine the first transformation with a second transformation, which second transformation transforms coordinates in the second coordinate system into coordinates in the third coordinate system.

19. An apparatus for performing coordinate transformation, which apparatus comprises:
a computing device comprising a processor and a memory, which memory comprises instructions for an off-set determiner module and an off-set applier module;
means for, with the off-set determiner module:
obtaining a first and a second anchor point in a first coordinate system and a first and a second anchor point in a second coordinate system, which first anchor points in the coordinate systems are corresponding anchor points because they were obtained at a first same location in the real world and which second anchor points in the coordinate systems are corresponding anchor points because they were obtained at a second same location in the real world,
determining that at least one set of the corresponding anchor points in the coordinate systems do not have the same values,
determining a transformation to make the corresponding anchor points in the coordinate systems have similar values and saving the transformation;
means for, with the off-set applier module module:
receiving a coordinate in the first coordinate system,
identifying an output coordinate system,
assembling an output transformation to transform the first coordinate into an output coordinate in the output coordinate system, which output transformation comprises the transformation,
transforming the coordinate in the first coordinate system into the output coordinate according to the assembled output transformation, and
outputting the output coordinate to a map system which utilizes the output coordinate system.

20. The apparatus according to claim 19, wherein the transformation is a first transformation, wherein the output coordinate system is a third coordinate system, and wherein assemble the output transformation comprises combine the first transformation with a second transformation, which second transformation transforms coordinates in the second coordinate system into coordinates in the third coordinate system.
